(19) United States
(12) Patent Application Publication
(10) Pub. No.: US 2026/0169488 A1
(43) Pub. Date: Jun. 18, 2026

(54) ELECTRONIC APPARATUS AND CONTROL METHOD THEREOF

(71) Applicant: SAMSUNG ELECTRONICS CO., LTD., Suwon-si (KR)

(72) Inventors: Dongjun Choi, Suwon-si (KR); Hyosung Kim, Suwon-si (KR); Boseok Moon, Suwon-si (KR); Muwoong Lee, Suwon-si (KR); Choongwon Seo, Suwon-si (KR)

(73) Assignee: SAMSUNG ELECTRONICS CO., LTD., Suwon-si (KR)

(21) Appl. No.: 19/440,220

(22) Filed: Jan. 5, 2026

Related U.S. Application Data
(63) Continuation of application No. PCT/KR2025/021265, filed on Dec. 10, 2025.

(30) Foreign Application Priority Data
Dec. 17, 2024 (KR) 10-2024-0189066

(51) Int. Cl. G05D 1/622; G05D 1/648; G06T 7/50; G06T 7/70; G06V 20/58

(52) U.S. Cl. CPC G05D 1/622; G05D 1/6484; G06T 7/50; G06T 7/70; G06T 2207/10028; G06T 2207/30261; G06V 20/58

(57) ABSTRACT

An electronic apparatus includes memory storing instructions, at least one sensor for sensing a space around the electronic apparatus, and at least one processor including processing circuitry, wherein the instructions, when executed by the at least one processor individually or collectively, cause the electronic apparatus to obtain first sensing data by sensing a work space corresponding to defined work information in the space through the at least one sensor, and based on identifying that a defined target object does not exist within a threshold distance from a first target position included in the work information on the basis of the first sensing data, obtain a second target position located within the threshold distance from the location of the defined target object on the basis of second sensing data obtained by sensing a different driving space from the work space.

### CROSS-REFERENCE TO RELATED APPLICATION(S)

This application is a continuation application, claiming priority under 35 U.S.C. § 365 (c), of an International application No. PCT/KR2025/021265, filed on Dec. 10, 2025, which is based on and claims the benefit of a Korean patent application number 10-2024-0189066, filed on Dec. 17, 2024, in the Korean Intellectual Property Office, the disclosure of which is incorporated by reference herein in its entirety.

### TECHNICAL FIELD

The disclosure relates to an electronic apparatus and a control method thereof, and more particularly, to an electronic apparatus that detects an environment around a destination of the electronic apparatus and obtains a new destination, and a control method thereof.

### BACKGROUND ART

As electronic technologies developed, various types of electronic apparatuses are being developed and distributed.

In particular, use of electronic products which can autonomously drive to a new destination is increasing. In response to user-inputted instructions to perform a certain task or item of work, these electronic products may move to a destination by themselves without a separate manipulation of the user.

Currently, electronic products are being developed which can generate and move along a new path to reach a destination in the event the environment around the destination changed such that the electronic product needs rerouting.

### SUMMARY

An electronic apparatus according to an embodiment of the disclosure may include memory storing instructions, at least one sensor for sensing a space around the electronic apparatus, and at least one processor including processing circuitry, wherein the instructions, when executed by the at least one processor individually or collectively, cause the electronic apparatus to obtain first sensing data by sensing a work space through the at least one sensor, the work space corresponding to defined work information in the space, and based on identifying, on the basis of the first sensing data, that a defined target object is not within a threshold distance from a first target position included in the defined work information, obtain a second target position within the threshold distance from a location of the defined target object on the basis of second sensing data obtained by sensing a driving space different from the work space.

The electronic apparatus may include a first sensor configured to sense the work space, and a second sensor at a different height from the first sensor, wherein the instructions, when executed by the at least one processor individually or collectively, may cause the electronic apparatus to sense, through the first sensor, the work space at a different height from the driving space, and obtain, through the second sensor, the second target position based on the second sensing data obtained by sensing the driving space.

The electronic apparatus may further include a mobile device configured to move the electronic apparatus, wherein the instructions, when executed by the at least one processor individually or collectively, may cause the electronic apparatus to control the mobile device to move to the first target position, and sense the work space through the at least one sensor while moving.

The instructions, when executed by the at least one processor individually or collectively, may cause the electronic apparatus to obtain the first target position based on previous sensing data obtained through the at least one sensor and the defined work information, and based on identifying that the defined target object is not within a threshold distance from the first target position on the basis of first sensing data different from the previous sensing data while moving to the first target position, obtain the second target position.

The instructions, when executed by the at least one processor individually or collectively, may cause the electronic apparatus to, based on at least one of the first sensing data or the second sensing data, identify at least one obstacle object in a target area within the threshold distance from the location of the defined target object, identify a remaining area of the target area excluding an area occupied by the identified at least one obstacle object in the target area, and obtain the second target position included in the remaining area.

The instructions, when executed by the at least one processor individually or collectively, may cause the electronic apparatus to identify at least one driving obstacle object located in the driving space on the basis of the second sensing data, and identify a remaining area of the driving space excluding an area occupied by the identified at least one driving obstacle object in the driving space.

The instructions, when executed by the at least one processor individually or collectively, may cause the electronic apparatus to obtain a plurality of candidate positions in the remaining area, obtain a plurality of scores based on destination characteristic information obtained from at least one of the first sensing data or the second sensing data, and obtain the second target position among the plurality of candidate positions included in the remaining area of the target area based on the plurality of scores.

The instructions, when executed by the at least one processor individually or collectively, may cause the electronic apparatus to obtain the destination characteristic information including information organized according to a plurality of types for each of the plurality of candidate positions from at least one of the first sensing data or the second sensing data, and obtain scores for each of the candidate positions based on a plurality of weights set for each of the plurality of types.

The instructions, when executed by the at least one processor individually or collectively, may cause the electronic apparatus to obtain path information wherein the obtained second target position is a destination based on the second sensing data, and update the defined work information based on the obtained path information and the second target position.

The instructions, when executed by the at least one processor individually or collectively, may cause the electronic apparatus to obtain motion information based on at least one driving obstacle identified from the second sensing data, and obtain path information including the obtained motion information.

A control method of an electronic apparatus according to an embodiment of the disclosure includes the steps of obtaining first sensing data by sensing a work space corresponding to defined work information in a space around the electronic apparatus, identifying whether a defined target object is within a threshold distance from a first target position included in the defined work information on the basis of the first sensing data, and based on identifying that the defined target object is not within the threshold distance, obtaining a second target position within the threshold distance from the location of the defined target object on the basis of second sensing data obtained by sensing a driving space different from the work space.

In the step of obtaining the first sensing data, the first sensing data may be obtained by sensing, through a first sensor, the work space at a different height from the driving space, and in the step of obtaining the second target position, the second target position may be obtained based on the second sensing data, the second sensing data obtained by sensing the work space through a second sensor at a different height from the first sensor.

The control method may further include the step of controlling the electronic apparatus to move the electronic apparatus to the first target position, wherein the step of obtaining the second target position may include the step of obtaining the second target position based on the second sensing data, the second sensing data obtained by sensing the work space while moving.

The control method may further include the step of obtaining the first target position based on previous sensing data and the defined work information, and in the step of identifying whether the defined target object is within the threshold distance, it may be identified whether the defined target object is within a threshold distance from the first target position on the basis of first sensing data different from the previous sensing data while moving to the first target position.

The step of obtaining the second target position may include the steps of, based on at least one of the first sensing data or the second sensing data, identifying at least one obstacle object in a target area within the threshold distance from the location of the defined target object, identifying a remaining area of the target area excluding an area occupied by the identified at least one obstacle object in the target area, and obtaining the second target position included in the remaining area.

In the step of identifying the at least one obstacle object, at least one driving obstacle object located in the driving space may be identified on the basis of the second sensing data, and in the step of identifying the remaining area, the remaining area excluding an area occupied by the identified at least one driving obstacle object may be identified in the target area.

The step of obtaining the second target position included in the remaining area may include the steps of obtaining a plurality of candidate positions included in the remaining area, obtaining a plurality of scores based on destination characteristic information obtained from at least one of the first sensing data or the second sensing data, and obtaining the second target position among the plurality of candidate positions included in the remaining area based on the plurality of scores.

In the step of obtaining the plurality of scores, the destination characteristic information including information organized according to a plurality of types for each of the plurality of candidate positions may be obtained from at least one of the first sensing data or the second sensing data, and scores for each of the candidate positions may be obtained based on a plurality of weights set for each of the plurality of types.

The control method may further include the steps of obtaining path information wherein the obtained second target position is a destination based on the second sensing data, and updating the defined work information based on the obtained path information and the second target position.

In a non-transitory computer-readable recording medium storing computer instructions which, when executed by a processor of an electronic apparatus, cause the electronic apparatus to perform operations according to an embodiment of the disclosure, the operations include the steps of obtaining first sensing data by sensing a work space corresponding to defined work information in a space around the electronic apparatus, identifying whether a defined target object is within a threshold distance from a first target position in the defined work information on the basis of the first sensing data, and based on identifying that the defined target object is not within the threshold distance, obtaining a second target position within the threshold distance from a location of the defined target object on the basis of second sensing data obtained by sensing a driving space different from the work space.

### BRIEF DESCRIPTION OF DRAWINGS

FIG. 1 is a diagram for schematically illustrating an operation of an electronic apparatus according to one or more embodiments of the disclosure;

FIG. 2 is a block diagram for illustrating a configuration of an electronic apparatus according to one or more embodiments of the disclosure;

FIG. 3 is a detailed block diagram for illustrating a detailed configuration of an electronic apparatus according to one or more embodiments of the disclosure;

FIG. 4 is a diagram for illustrating an operation of an electronic apparatus according to one or more embodiments of the disclosure;

FIG. 5 is a flow chart for illustrating an operation of an electronic apparatus according to one or more embodiments of the disclosure;

FIG. 6 is a flow chart for illustrating an operation of modifying a destination according to one or more embodiments of the disclosure;

FIG. 7 is a flow chart for illustrating an operation based on an upper map according to one or more embodiments of the disclosure;

FIG. 8 is a flow chart for illustrating, in detail, an operation of modifying a destination according to one or more embodiments of the disclosure;

FIG. 9 is a flow chart for illustrating an operation of obtaining a new destination according to a score, according to one or more embodiments of the disclosure; and

FIG. 10 is a diagram for illustrating weights according to one or more embodiments of the disclosure.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, and they should be interpreted to include various modifications, equivalents, and/or alternatives of the embodiments of the disclosure. Also, with respect to the detailed description of the drawings, similar components may be designated by similar reference numerals.

Also, in the event it is determined that in describing the disclosure, detailed explanation of related known functions or configurations may unnecessarily confuse the gist of the disclosure, the detailed explanation may be ignored and/or omitted.

In addition, one or more of the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Further, terms used in the disclosure are used to explain specific embodiments, and are not intended to limit the scope of the disclosure. Also, singular expressions may include plural expressions, unless defined obviously differently in the context.

Also, in the disclosure, expressions such as “have,” “may have,” “comprise,” “may comprise,” “include,” and “may include” denote the existence of such characteristics (e.g., elements such as numbers, functions, operations, and components), and do not exclude the existence of additional characteristics.

In addition, in the disclosure, the expressions “A or B,” “at least one of A and/or B,” or “one or more of A and/or B” and the like may include all possible combinations of the listed items. For example, “A or B,” “at least one of A and B,” or “at least one of A or B” may refer to all of the following cases: (1) including at least one A, (2) including at least one B, or (3) including at least one A and at least one B.

Further, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g., a first element) is “(operatively or communicatively) coupled with/to” or “connected to” another element (e.g., a second element) should be interpreted to include both the instance where the one element is directly coupled to the another element, and the instance where the one element is coupled to the another element through still another element (e.g., a third element).

In contrast, the description that one element (e.g., a first element) is “directly coupled” or “directly connected” to another element (e.g., a second element) can be interpreted to mean that still another element (e.g., a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g., an embedded processor) for performing the corresponding operations, or a generic-purpose processor (e.g., a CPU or an application processor) that can perform the corresponding operations by executing one or more software programs stored in a memory device.

Also, in one or more embodiments of the disclosure, ‘a module’ or ‘a part’ may perform at least one function or operation, and may be implemented as hardware or software, or as a combination of hardware and software. In addition, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, embodiments according to the disclosure will be described in detail with reference to the accompanying drawings, such that those having ordinary skill in the art to which the disclosure belongs can carry out the disclosure.

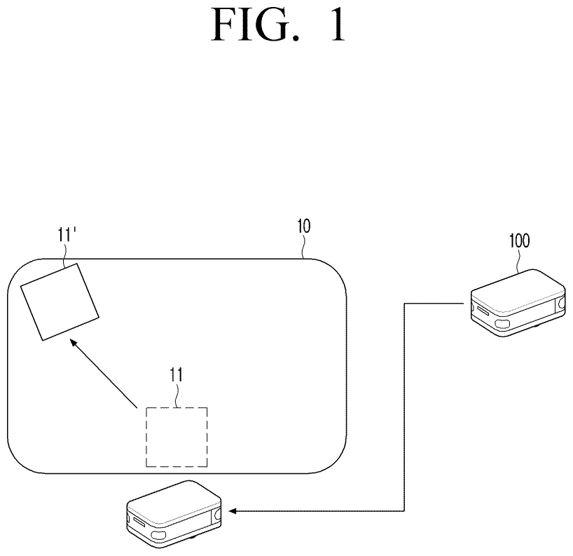

FIG. 1 is a diagram for schematically illustrating an operation of an electronic apparatus according to one or more embodiments of the disclosure.

According to FIG. 1, an electronic apparatus 100, a work space 10, and a target 11 are illustrated.

Here, each of the electronic apparatus 100, the work space 10, and the target 11 may be illustrated in forms as illustrated in FIG. 1, but they are not necessarily limited thereto, and may be implemented in various forms.

The electronic apparatus 100 may be implemented as at least one of a smartphone, a tablet personal computer (PC), a desktop PC, a laptop PC, a PC, a set-top box, an over-the-top (OTT) media service server, a console (a video game console), a Blu Ray player, a digital video disc or a digital versatile disc (DVD) player, a home automation control panel, a security control panel, a media box (e.g., Samsung HomeSync™, Apple TV™, or Google TV™), or a game console (e.g., Xbox™, PlayStation™). However, the electronic apparatus 100 is not limited thereto.

For example, the electronic apparatus 100 may be implemented as a server that can control an external device that can drive. Here, the external device that can move may fall under a device that can receive a control signal from the electronic apparatus 100 and perform a specific operation.

Here, the control signal may fall under a signal that the electronic apparatus 100 generated such that the external device performs a specific operation. For example, the electronic apparatus 100 may generate a control signal to perform a specific operation by using information provided by the external device (e.g., the current location of the external device, a set destination, etc.).

Here, the specific operation may mean an operation of the electronic apparatus 100 involving moving by driving to a specific place or performing a specific work in a specific place. However, the disclosure is not limited thereto.

Meanwhile, the electronic apparatus 100 may also be implemented as an apparatus that can drive by itself. For example, the electronic apparatus 100 may be implemented as a driving robot. The driving robot may mean an apparatus that can move by itself along the ground surface or a specific surface by using wheels, legs, or other moving means.

In case the electronic apparatus 100 is implemented as a driving robot, the electronic apparatus 100 may fall under a robot located in a home. For example, the electronic apparatus 100 may provide various services such as housework, education, health care, etc. to a user. However, this is merely an example, and the electronic apparatus 100 is not limited to a home service robot as above.

Meanwhile, the electronic apparatus 100 may fall under a robot located in an office, a store, a storage, etc. In this case, the electronic apparatus 100 may perform a work (i.e., “a job”, “a work task”, or “an item of work”) of moving a specific object. For example, the electronic apparatus 100 may perform various functions such as carrying an object of a user and moving to follow the user, or carrying an object placed in a specific place and moving the object to a designated space, etc.

In case the electronic apparatus 100 is implemented as a driving robot that can move as described above, the electronic apparatus 100 may drive by using map information for the space wherein the electronic apparatus 100 is located (e.g., a storage). Here, the map information may mean data for the space wherein the electronic apparatus 100 is located.

For example, the electronic apparatus 100 may use map information including the structure, obstacles, topographic information, etc. of the ambient environment used for performing planning of a path and moving. Here, the ambient environment may mean the space around the electronic apparatus 100.

Here, the ambient space may include a driving space for the electronic apparatus 100 to move, and a separate work space 10 wherein the electronic apparatus 100 performs a specific work (a work other than driving).

The work space 10 may mean a space wherein an object related to a work performed by the electronic apparatus 100 is placed. In other words, the work space 10 may mean a space located on a structure such as a desk, a shelf, etc. in case the electronic apparatus 100 performs a specific work (e.g., a work of moving an object placed on a specific structure, etc.).

Meanwhile, the driving space may mean a space wherein the electronic apparatus 100 can move, separately from the work space 10. In other words, the driving space may mean a space located on a bottom surface used by the electronic apparatus 100 for moving. Also, the driving space may include an area wherein the electronic apparatus 100 can physically move

For example, the driving space may mean a space wherein a direct interaction with a specific object (an object related to a specific work) is not performed, unlike the work space 10.

Meanwhile, the electronic apparatus 100 may perform a work for the target 11 located on the work space 10. Here, the target 11 may mean an object which is a subject for a work that the electronic apparatus 100 will perform in the work space 10.

In other words, the target 11 may mean an object selected for a specific work such as moving, manipulation, etc. For example, the target 11 may fall under a box, table, chair, furniture, etc. placed on the work space 10 such as a shelf. However, the target 11 is not limited thereto.

For example, the electronic apparatus 100 may perform a work for moving the target 11 located on the work space 10 to another place.

Here, the another place may mean a place other than spaces located around the electronic apparatus 100 (the driving space and the work space 10). However, the disclosure is not limited thereto, and the another place may mean a location (a place) different from the original location of the target 11 in the work space 10.

The electronic apparatus 100 may move to the vicinity of the location wherein the target 11 was originally located for performing the above work. Here, the original location of the target 11 may constitute information included in the map information. In other words, the electronic apparatus 100 may identify the location of the target 11 by using the map information, and move to the vicinity of the location.

Meanwhile, in case the electronic apparatus 100 moved to the vicinity of the original location of the target 11, it may fail to perform the work. For example, while the electronic apparatus 100 is moving to the vicinity of the original location, the target 11 may disappear from the original location.

Here, the electronic apparatus 100 may not be able to detect that the target 11 disappeared from the original location. In other words, although the electronic apparatus 100 may be able to sense the driving space, it may not be able to sense the work space 10. For example, in the event the work space 10 is located higher than the driving space, the work space 10 may not be sensed due to the sensing range of the electronic apparatus 100.

Here, the sensing range may mean a field of view and a sensing distance. Here, the field of view (FOV) may mean an angle of a view in which a sensor can detect the ambient environment. The sensing distance may mean the maximum distance at which a sensor can recognize a specific object or the environment, or collect data.

In the event the electronic apparatus 100 cannot sense the work space 10 due to the sensing range, it may not be able to detect a change in the work space 10.

In this scenario, the electronic apparatus 100 may move near a new location, and perform a work for the moved target 11′. For example, the electronic apparatus 100 may generate a path for going to the vicinity of the new location of the moved target 11′. Here, the electronic apparatus 100 may generate a path by using the map information for the driving space.

Here, in the event the electronic apparatus 100 cannot sense the work space 10 as above, the electronic apparatus 100 may obtain information for the new location of the moved target 11′ from an external device, for example. However, the disclosure is not limited thereto, and the electronic apparatus 100 may move to a location wherein it can sense the work space 10 by itself, and detect the new location by sensing the work space 10.

In the event the target 11 moved from the previous location to a new location as above, the electronic apparatus 100 may not be able to perform a specific work in the original location of the target 11. In this case, the electronic apparatus 100 may move to a new place (near the location of the moved target 11′) for performing the specific work for the moved target 11′. For this, the electronic apparatus 100 may generate a path for moving to the new location.

In case the electronic apparatus 100 cannot detect a change in the environment of the work space 10 due to limitation on the sensing range, for example, it may generate a new path from the previous location of the target 11 again, and move to a new location.

For this, the electronic apparatus 100 should perform an operation of generating a path twice (or more), and should additionally move for performing a work for the target 11.

However, in the event the electronic apparatus 100 can recognize the environment of the work space 10 in advance, it may generate a new path before arriving near the previous location of the target 11 (the original destination). In other words, the electronic apparatus 100 may obtain a new destination by continuously detecting the environment of the work space 10 while moving to the original destination. Detailed explanation in this regard will be described below.

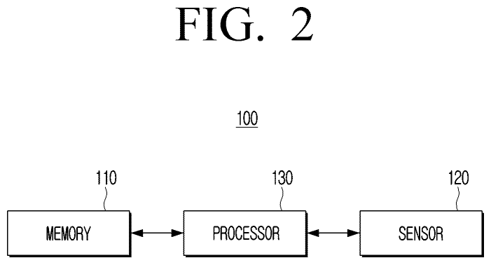

FIG. 2 is a block diagram for illustrating a configuration of an electronic apparatus according to one or more embodiments of the disclosure.

According to FIG. 2, the electronic apparatus 100 may include memory 110, a sensor 120, and a processor 130.

As the electronic apparatus 100 was explained in FIG. 1, overlapping explanation will be omitted.

In the case of memory embedded in the electronic apparatus 100, the memory may be implemented as at least one of volatile memory (e.g., dynamic RAM (DRAM), static RAM (SRAM), or synchronous dynamic RAM (SDRAM), etc.) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD)), etc. Meanwhile, in the case of memory that can be attached to or detached from the electronic apparatus 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.) and external memory that can be connected to a USB port (e.g., a USB memory), etc.

The memory 110 may include one or more storage media (or one or more storage devices). For example, the memory 110 may include a memory assembly including one or more storage media. For example, the one or more storage media may include permanent memory (e.g., non-volatile memory) such as a hard drive, flash memory, and read-only memory (ROM), semi-permanent memory (e.g., volatile memory) such as random access memory (RAM), a storage (or a storage assembly) of any other suitable type, or any combination thereof. The memory 110 may include cache memory which is memory of one or more different types that is used for temporarily storing data for the functions or the features of the electronic apparatus 100. As an unlimited example, the cache memory may be included inside the processor 130. The memory 110 may be fixedly embedded in the electronic apparatus 100, or incorporated into one or more suitable types of components (e.g., a subscriber identity module (SIM) card and/or a secure digital (SD) card) that can be repeatedly inserted into the electronic apparatus 100 and can be removed from the electronic apparatus 100.

For example, the memory 110 may store one or more software applications such as an operating system (or a system) software application, a firmware software application, a driver software application, a plug-in (e.g., an add-in, an add-on, and/or an applet) software application, and/or any other suitable software application. For example, the one or more software applications may include instructions that can be executed by the processor 130. For example, the memory 110 may store instructions that can be called by an application programming interface (API). For example, the memory 110 may store instructions within a library.

In the disclosure, the term memory 110 may include, describe, or relate to a storage part, ROM and RAM inside the at least one processor 130, or a memory card (e.g., a micro SD card, a memory stick) installed on the electronic apparatus 100.

The memory 110 according to one or more embodiments may store at least one instruction. The at least one instruction stored in the memory 110 may make the electronic apparatus 100 perform operations when it is individually or collectively executed by the processor 130.

Here, the at least one instruction may fall under at least one instruction for the electronic apparatus 100 to obtain a second target position by sensing the ambient space of the electronic apparatus 100. The memory 110 may store information necessary for the operations of the electronic apparatus 100 other than the above.

The sensor 120 may sense the ambient space of the electronic apparatus 100. The sensor 120 may include at least one of an image sensor, a LiDAR sensor, an obstacle detection sensor, or a driving detection sensor. The sensor 120 may generate sensing data by sensing the ambient space of the electronic apparatus 100.

The electronic apparatus 100 may include one sensor 120, but the disclosure is not limited thereto, and the sensor may be implemented as a plurality of sensors 120. Hereinafter, explanation will be described by assuming a case wherein the sensor 120 is implemented as at least one sensor 120 for the convenience of explanation.

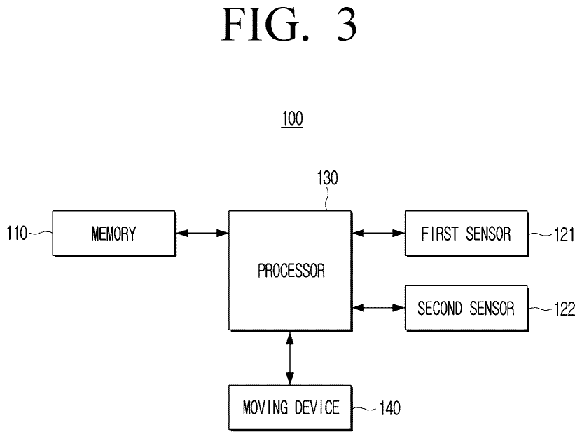

According to an embodiment, the sensor 120 may include a first sensor and a second sensor. Here, the first sensor and the second sensor may fall under sensors arranged in different locations of the electronic apparatus 100. Detailed explanation in this regard will be described in FIG. 3.

The processor 130 may perform overall control operations of the electronic apparatus 100.

The processor 130 may be implemented as a digital signal processor (DSP) processing digital signals, a microprocessor, and a time controller (TCON). However, the disclosure is not limited thereto, and the processor 130 may include one or more of a central processing unit (CPU), a micro controller unit (MCU), a micro processing unit (MPU), a controller, an application processor (AP), a graphics-processing unit (GPU) or a communication processor (CP), and an ARM processor, or may be defined by the terms. Also, the processor 130 may be implemented as a system on chip (SoC) having a processing algorithm stored therein or large scale integration (LSI), or in the form of a field programmable gate array (FPGA). The processor 130 may perform various functions by executing computer executable instructions stored in the memory. Meanwhile, in FIG. 2, it was illustrated that only one processor is included in the electronic apparatus 100, but in actual implementation, a plurality of processors (e.g., a CPU+ a GPU, a CPU+ a DSP) may be included.

Meanwhile, the aforementioned instructions stored in the memory 110 may make the electronic apparatus 100 perform operations as follows when they are individually or collectively executed by the processor 130.

According to one or more embodiments, the electronic apparatus 100 may obtain the first sensing data by sensing a work space through the at least one sensor 120. Here, as the work space was explained in detail above, overlapping explanation will be omitted.

Here, the work space may constitute a space corresponding to defined work information in the space around the electronic apparatus 100. Here, the work information may constitute information including the content of a work that the electronic apparatus 100 should perform for a target in a specific space.

Specifically, the work information may include the target and the location, etc. of the work that the electronic apparatus 100 will perform. Here, the work space may mean a space wherein the subject (the target) of the work to be performed exists in the work information. Here, the space wherein the target exists may mean a space on a specific structure wherein the target is placed. However, the disclosure is not limited thereto.

Here, the sensing data may constitute data that the electronic apparatus 100 obtained by sensing the ambient space through the at least one sensor 120.

Here, in the event the at least one sensor 120 is implemented as an image sensor, the sensing data may constitute data (digital data) obtained from visual information of the ambient environment captured through a camera. For example, the sensing data may constitute data including pixel information (the brightness and the color values of each pixel) of the captured work space.

Meanwhile, in the event the least one sensor 120 is implemented as a LiDAR sensor, the sensing data may constitute data that expressed a distance to an object (or a 3D location) based on the reflection time of a laser pulse. Here, the sensing data may constitute point cloud data.

Here, the point cloud data may constitute data that expressed the form of an object or an environment in a digital form by collecting the coordinates (x, y, z) of each point in a 3D space.

For example, the sensing data may include distance values of each point (or points indicating distance values) collected for identifying the locations of obstacles, etc. of a space.

The sensing data is not limited to the aforementioned example, and in the event the at least one sensor 120 is implemented as a sensor of a different type, the sensing data may be implemented as data in various forms.

Meanwhile, the first sensing data may constitute sensing data that the electronic apparatus 100 obtained by sensing the work space. In other words, the first sensing data may include information on the work space (the distance or the location, etc. of an obstacle or a target).

According to one or more embodiments, the electronic apparatus 100 may identify whether a defined target object exists within a threshold distance from a first target position included in the work information based on the first sensing data.

Here, the first target position may constitute a destination to which the electronic apparatus 100 should move for performing a specific work. Here, the information on the destination (e.g., the location and the path, etc.) may constitute information included in the aforementioned work information.

Here, the target object may mean the aforementioned target. In other words, the target object may mean a target located in the work space.

Here, the target may constitute a subject object for the electronic apparatus 100 to perform a specific work. For example, in the event the electronic apparatus 100 performs a work for moving a delivery box, the target object may constitute the delivery box.

Here, the threshold distance may constitute a distance according to a motion range in which the electronic apparatus 100 can perform a work. Here, the motion range may mean a range of a distance or an angle in which the electronic apparatus 100 can perform a work in a specific location. Here, the distance corresponding to the motion range may constitute a distance in which the electronic apparatus 100 can perform a work in a specific location.

For example, the electronic apparatus 100 may include a robot arm. In this case, the electronic apparatus 100 may perform a work by using the robot arm. Here, the robot arm may constitute a device for the electronic apparatus 100 to perform a work such as gripping or moving an object (e.g., a target object).

For example, the robot arm may include joints and links that are operable. Here, the operable joints may provide a rotation function by connecting the links in the robot arm. Here, the links may mean structures of a fixed length that connect between the joints in the robot arm.

Meanwhile, the robot arm may be arranged in the upper part of the electronic apparatus 100. For example, in the event the electronic apparatus 100 performs a specific work in a work space in a higher location than the driving space, the electronic apparatus 100 may perform the work by using the robot arm arranged in the upper part of the electronic apparatus 100 (i.e., the same height as the work space). However, the disclosure is not limited thereto.

Here, the electronic apparatus 100 may perform the work by using the robot arm arranged at a different height from the moving device. In this case, the electronic apparatus 100 may sense the work space by using a sensor attached on the robot arm. A detailed content in this regard will be described in the following parts.

In case the electronic apparatus 100 includes a robot arm as above, the threshold distance may constitute a distance according to a motion range of the robot arm. Here, the motion range of the robot arm may mean a range of the maximum distance (or angle) in which the robot arm can move or perform a work. In this case, the threshold distance may mean the aforementioned maximum distance.

Meanwhile, the electronic apparatus 100 may identify that a target object does not exist within (i.e., is not located or positioned within) the threshold distance from the first target position based on the first sensing data.

For example, the electronic apparatus 100 may use map information of the work space obtained through the first sensing data. Here, the map information of the work space may include information on the structure of the work space, the locations of the objects, etc.

The electronic apparatus 100 may identify the location of the target object by using the map information of the work space. Then, the electronic apparatus 100 may identify whether the identified target object is within the threshold distance from the first target position.

If it is identified that the target object is not located within the threshold distance, the electronic apparatus 100 may identify that the target object does not exist within the threshold distance.

According to one or more embodiments, if it is identified that a defined target object does not exist within the threshold distance, the electronic apparatus 100 may obtain the second target position located within the threshold distance from the location of the target object based on the second sensing data.

Here, the second sensing data may constitute sensing data that the electronic apparatus 100 obtained by sensing the driving space. Here, the driving space may constitute a space different from the work space in the space around the electronic apparatus 100. As the sensing data and related aspects were explained above, overlapping and/or redundant explanation(s) may be omitted.

The location of the target object may constitute a location identified based on the first sensing data. In other words, the electronic apparatus 100 may identify the location of the target object based on the aforementioned map information of the work space. The location of the target object may be located on the work space.

If the electronic apparatus 100 identifies that the target object does not exist on the work space based on the first sensing data, the electronic apparatus 100 may identify that the work failed.

Meanwhile, the electronic apparatus 100 may obtain the second target position located within the threshold distance from the identified location of the target object. In other words, the electronic apparatus 100 may obtain the second target position wherein it can perform a work for the target object.

Here, the second target position may constitute a position on the driving space that the electronic apparatus 100 obtained based on the second sensing data. Also, the second target position may constitute a position wherein the electronic apparatus 100 can perform a work for the target object located on the work space. In other words, the second target position may constitute a position that was updated from the first target position to a position wherein the electronic apparatus 100 can perform a work.

According to an embodiment, the electronic apparatus 100 may identify at least one obstacle object based on at least one of the first sensing data or the second sensing data.

Here, as the at least one obstacle object, the electronic apparatus 100 may identify at least one obstacle object included in a target area of the target object. Here, the target area may constitute an area which is within a threshold distance from the location of the target object.

Specifically, the target area may constitute an area that belongs to the driving space among areas within the threshold distance from the location of the target object. However, the disclosure is not limited thereto.

Here, the obstacle object is an object that may interfere with moving or a work of the robot in the driving space or the work space, and it may mean an object identified through the sensing data. Here, the obstacle object may constitute an object different from the target object.

Specifically, the electronic apparatus 100 may identify an obstacle object based on at least one of the first sensing data or the second sensing data.

For example, the electronic apparatus 100 may identify an obstacle object located on the work space by using the map information of the work space obtained based on the first sensing data. However, the disclosure is not limited thereto, and the electronic apparatus 100 may identify an obstacle object located on the driving space by using the map information of the work space.

Meanwhile, the electronic apparatus 100 may identify an obstacle object located on the driving space by using the map information of the driving space obtained based on the second sensing data. However, the disclosure is not limited thereto, and the electronic apparatus 100 may identify an obstacle object located on the work space by using the map information of the driving space.

In other words, in the event the work space and the driving space are adjacent, an obstacle object located on the driving space may be identified through the first sensing data. Also, in the event the work space and the driving space are adjacent, an obstacle object located on the work space may be identified through the second sensing data.

Also, the electronic apparatus 100 may identify at least one obstacle object located in at least one of the work space or the driving space by using both of the aforementioned map information of the work space and map information of the driving space. In other words, the electronic apparatus 100 may consider all of the obstacle objects that may be located in both of the work space and the driving space for identifying the second target position.

Meanwhile, the electronic apparatus 100 may identify the remaining area excluding the area occupied by the at least one identified obstacle object in the target area. Here, the remaining area may constitute an area located on the driving space.

According to one or more embodiments, the electronic apparatus 100 may identify at least one driving obstacle object based on the second sensing data. Here, the driving obstacle object may mean an obstacle object located in the driving space.

For example, the obstacle object may constitute an object such as a box that fell on a driving space, or the bottom of a trash can that may block a driving path, but the obstacle object is not limited thereto and may include any object or terrain that may impede or hinder the free movement of the electronic apparatus 100.

The electronic apparatus 100 may identify the remaining area excluding the area occupied by the at least one identified driving obstacle object in the target area.

Meanwhile, the electronic apparatus 100 may obtain the second target position included in the remaining area.

According to one or more embodiments, the electronic apparatus 100 may obtain a plurality of candidate positions included in the remaining area. Here, the plurality of candidate positions may be included in the remaining area, and may constitute candidate positions of a defined number. Here, the defined number may be set based on the size of the remaining area. However, the disclosure is not limited thereto, and the defined number may be set by a manipulation input of the user for selecting the number of the candidate positions.

Meanwhile, the electronic apparatus 100 may obtain a plurality of scores based on destination characteristic information.

Here, the destination characteristic information may mean environment information of the surroundings of the destination obtained through the sensing data. For example, the destination characteristic information may include the type, the location, the size, etc. of an obstacle object located in the driving space or the work space. However, the disclosure is not limited thereto, and the destination characteristic information may include distances to each of the candidate positions based on the current electronic apparatus 100.

Here, the electronic apparatus 100 may obtain destination characteristic information from at least one of the first sensing data or the second sensing data. For example, the destination characteristic information may include information distinguished according to a plurality of types for each of the plurality of candidate positions.

Here, the plurality of types may include types regarding the types, the locations, etc. of the aforementioned obstacle objects, and types regarding the distances to each of the candidate places, for example. However, the disclosure is not limited thereto, and the plurality of types may include types regarding ranges in which the robot arm should be operated for each of the candidate positions.

Here, the ranges in which the robot arm should be operated may mean ranges in which the electronic apparatus 100 should operate for performing a work in a specific candidate position (e.g., the ranges of a distance, an angle, etc. in which the robot arm is stretched out).

The electronic apparatus 100 may obtain scores for each of the candidate positions based on a plurality of weights set for each of the plurality of types. Here, the weights may constitute values set for each of the plurality of types included in the destination characteristic information.

Here, the weights may constitute values set for each type of the destination characteristic information for calculating scores. Here, the importance may indicate the degree to which the information of each type exerts influence when an optimal candidate position is selected.

Meanwhile, the electronic apparatus 100 may obtain the second target position among the plurality of candidate positions included in the remaining area based on the plurality of scores. For example, the electronic apparatus 100 may obtain a candidate position corresponding to the highest score among the plurality of scores as the second target position.

Accordingly, the electronic apparatus 100 may calculate scores according to the ambient environment of each of the candidate positions, and obtain a final destination based on the scores calculated for each of the candidate positions. Through this, the electronic apparatus 100 may effectively obtain a final destination that can minimize power consumption.

According to one or more embodiments, the electronic apparatus 100 may obtain path information wherein the obtained second target position is the destination based on the second sensing data.

For example, the electronic apparatus 100 may use map information of the driving space obtained based on the second sensing data. Specifically, the electronic apparatus 100 may identify an obstacle object (e.g., a driving obstacle object) located between the electronic apparatus 100 and the second target position from the map information of the driving space.

The electronic apparatus 100 may obtain path information based on the location and the size of the identified obstacle object. Here, the path information may mean information on an optimal moving path that the electronic apparatus 100 should follow for moving to the second target position.

Here, the path information may include a moving direction, an intermediate stopover, an obstacle evasive path, a moving distance, and/or a predicted time, etc.

As an example, the electronic apparatus 100 may obtain motion information based on at least one driving obstacle object identified from the second sensing data. Here, the motion information may mean information regarding a posture of the electronic apparatus 100 for moving along a path or performing a work.

For example, the motion information may include the rotation angles of each joint and the driving speed of the robot arm, and the rotation angle of the electronic apparatus 100 for avoiding an obstacle. However, the disclosure is not limited thereto.

The electronic apparatus 100 may obtain path information including the obtained motion information. Meanwhile, the electronic apparatus 100 may update the work information based on the obtained path information and the second target position.

Afterwards, the electronic apparatus 100 may repeat the aforementioned processes according to the updated work information. For example, the electronic apparatus 100 may update the previous work information to work information including the second target position. In other words, the electronic apparatus 100 may update the second target position to a new first target position.

Accordingly, the electronic apparatus 100 may identify that a change of the environment around the first target position (e.g., moving of the target object) occurred based on the new first sensing data that was obtained by sensing the work space again. In this case, the electronic apparatus 100 may obtain a new second target position based on the newly obtained second sensing data.

In FIG. 2, it was illustrated that the electronic apparatus 100 includes only basic components, but the electronic apparatus 100 may further include various components other than the aforementioned components.

FIG. 3 is a detailed block diagram for illustrating a detailed configuration of an electronic apparatus according to one or more embodiments of the disclosure.

According to FIG. 3, the electronic apparatus 100 may include memory 110, a first sensor 121, a second sensor 122, a processor 130, and a moving device 140. Here, as the memory 110 and the processor 130 were already explained, explanation will be described while excluding overlapping explanation.

The electronic apparatus 100 may include the first sensor 121 and the second sensor 122.

According to one or more embodiments, the first sensor 121 may constitute a sensor for sensing a work space. For example, the first sensor 121 may be arranged at a height smaller than or substantially equal to a threshold range from the height of the work space. Here, the work space may be arranged at a different height from a driving space. Also, here, the threshold range may be defined according to a range of sensing angles of the first sensor 121.

Here, in the event the electronic apparatus 100 further includes the aforementioned robot arm, the first sensor 121 may be located on the robot arm. For example, the first sensor 121 may be located in the end part of the robot arm. Here, the end part may constitute a part wherein the robot arm and an object contact in the event the electronic apparatus 100 performs a work such as lifting an object by using the robot arm, for example.

In this scenario, the electronic apparatus 100 may sense a work space that is located in the same location as the robot arm or located within the threshold range through the first sensor 121. Accordingly, the electronic apparatus 100 may sense an ambient environment (a work space) related to a specific work at the same time as performing the specific work without a separate additional sensor (a sensing device, etc. outside the electronic apparatus 100), through the first sensor 121 separately attached on the robot arm.

Meanwhile, the second sensor 122 may constitute a sensor for sensing a driving space. For example, the second sensor 122 may be arranged at a different height from the first sensor 121. Also, the second sensor 122 may be arranged at a height smaller than or substantially equal to a threshold range from the height of the driving space.

Each of the aforementioned first sensor 121 and second sensor 122 may be arranged in fixed locations of the electronic apparatus 100, and the locations may be changed through a driving device that is separately provided. For example, the electronic apparatus 100 may sense the space around the electronic apparatus 100 by adjusting the location of at least one of the first sensor 121 or the second sensor 122 through the driving device.

According to one or more embodiments, the electronic apparatus 100 may sense a work space at a different height from the driving space through the first sensor 122. The electronic apparatus 100 may obtain the second target position based on the second sensing data obtained by sensing the driving space through the second sensor 122.

Here, as the operation of the electronic apparatus 100 of obtaining the second target position based on the second sensing data was explained above, overlapping and/or redundant explanation(s) may be omitted.

Meanwhile, the electronic apparatus 100 may include a moving device 140. Here, the moving device 140 may constitute a component for moving the electronic apparatus 100. For example, the moving device 140 may include a wheel, a driving motor, a suspension, etc.

According to one or more embodiments, the electronic apparatus 100 may control the moving device 140 such that the electronic apparatus 100 moves to the first target position.

For example, the electronic apparatus 100 may obtain the first target position based on the previous sensing data and work information.

Here, the previous sensing data may constitute sensing data that the electronic apparatus 100 obtained through at least one sensor (e.g., at least one of the first sensor 121 or the second sensor 122) before obtaining the first target position. Also, here, the previous sensing data may constitute sensing data that the electronic apparatus 100 obtained by sensing the work space.

The electronic apparatus 100 may identify the first target position based on the previous map information obtained through the previous sensing data and the work information. For example, the electronic apparatus 100 may identify the first target position by using information on a target object (e.g., the size, the shape, or the (previous) location, etc. of the target object) included in the work information.

Here, the first target position may constitute a position within a threshold distance from the previous location of the target object. Here, the position within the threshold distance may constitute a position on the driving space. Here, as the threshold distance and related aspects were explained in detail above, overlapping and/or redundant explanation(s) may be omitted.

According to one or more embodiments, the electronic apparatus 100 may sense a work space through the sensor while moving. The electronic apparatus 100 may obtain the first sensing data by sensing the work space while moving.

According to one or more embodiments, the electronic apparatus 100 may identify whether a defined target object exists within the threshold distance from the first target position based on the first sensing data while moving to the first target position. Here, the first sensing data may constitute data different from the previous sensing data.

If it is identified that a target object does not exist within the threshold distance, the electronic apparatus 100 may obtain the second target position. As the operation of obtaining the second target position was explained in detail above, overlapping explanation will be omitted.

Accordingly, the electronic apparatus 100 may detect a change in the environment of the previous destination while moving to the previous destination (e.g., the first target position) according to defined work information. In other words, the electronic apparatus 100 may recognize a change of the environment, such as whether the target object moved, while obtaining new sensing data (the first sensing data) different from the previous sensing data.

Through this, the electronic apparatus 100 can continuously modify the path by sensing the ambient environment in real time during driving, and thus it can obtain an optimal destination and an optimal path through which power consumption can be minimized.

Meanwhile, in FIGS. 2 and 3, an electronic apparatus 100 including various additional components was illustrated, but the electronic apparatus 100 may be implemented in a form wherein some components among the illustrated components are omitted. Also, the electronic apparatus 100 may further include other components.

For example, the electronic apparatus 100 may include a robot arm for performing a work. Here, as the operation of the robot arm was explained in detail above, overlapping and/or redundant explanation(s) may be omitted.

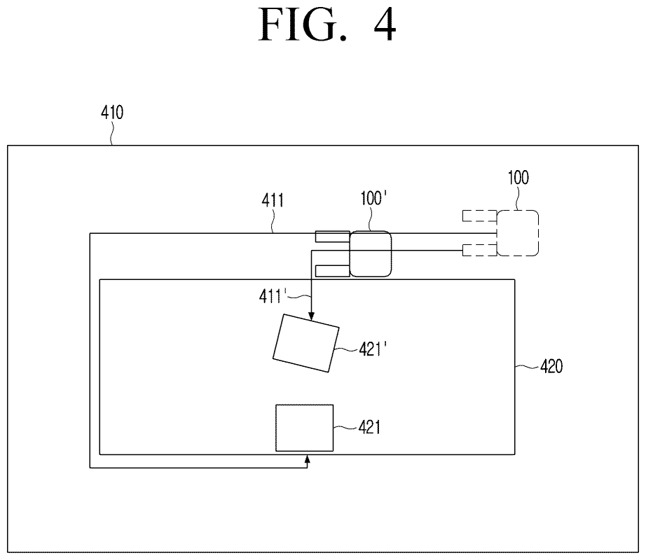

FIG. 4 is a diagram for illustrating an operation of an electronic apparatus according to one or more embodiments of the disclosure.

According to FIG. 4, an electronic apparatus 100, an ambient space 410, a work space 420, a first path 411, a second path 411′, a target object 421, etc. are illustrated.

The electronic apparatus 100 may drive in the ambient space 410 of the electronic apparatus 100. For example, the electronic apparatus 100 may drive in the driving space excluding the work space 420 in the ambient space 410.

The electronic apparatus 100 may move to the place wherein the target object 421 is located. Specifically, the electronic apparatus 100 may move to the vicinity of the place wherein the target object 421 is located through the first path 411. Here, the first path 411 may constitute a path included in the defined work information.

The electronic apparatus 100 may move to the vicinity of the place wherein the target object 421 is located along the first path 411. Here, the vicinity may constitute the aforementioned first target position. As the first target position and related aspects were explained above, overlapping and/or redundant explanation(s) may be omitted.

While the electronic apparatus 100 is moving on the first path 411, the target object may be moved to another location. Here, the another location may constitute a location that exceeds the threshold distance from the first target position.

In this scenario, if the electronic apparatus 100 arrives at the first target position by moving through the first path 411, the target object 421 may have already moved, and thus the electronic apparatus 100 may fail to perform the work. Accordingly, the electronic apparatus 100 may need to move to a new location for performing a work for the moved target object 421′.

Here, the new location may constitute the second target position. Also, here, as the second target position and related aspects were explained above, overlapping and/or redundant explanation(s) may be omitted.

Meanwhile, in the event the electronic apparatus 100 can detect that the target object 421 moved before arriving at the aforementioned first target position, the electronic apparatus 100 may move to the second target position through the second path 411′.

After moving to the second target position, the electronic apparatus 100 may perform a work for the moved target object 421′. Here, the moved target object 421′ may be within the threshold distance from the second target position.

For this, in the event the electronic apparatus 100 can detect that the target object 421 moved, the electronic apparatus 100 may obtain the position wherein it can perform a work for the moved target object 421′ (in other words, a position within the threshold distance from the location of the moved target object 421′) as the second target position.

Through this, the electronic apparatus 100 may obtain a new destination (the second target position) by detecting a change in the environment of the work space 420 (e.g., moving of the target object 421, etc.) in advance without arriving at the first target position.

Here, detecting in advance may mean that the electronic apparatus 100 detects a change in the environment before going beyond the vicinity of the moved target object 421′. Here, the vicinity of the moved target object 421′ may mean an area within the threshold distance from the location of the moved target object 421′. However, the disclosure is not limited thereto.

Accordingly, instead of moving to the second target position after arriving at the first target position, the electronic apparatus 100 can perform a work by directly moving to the second target position, and thus there is an effect that the moving path can be optimized, and at the same time, power consumption can be reduced.

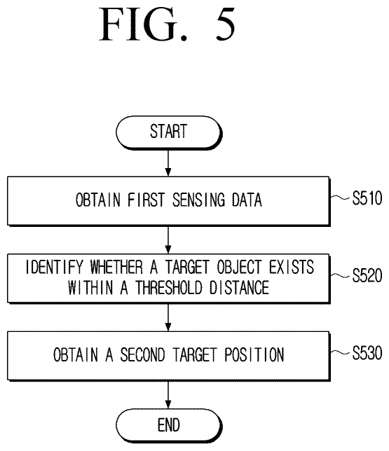

FIG. 5 is a flow chart for illustrating an operation of an electronic apparatus according to one or more embodiments of the disclosure.

According to FIG. 5, the electronic apparatus 100 may obtain the first sensing data in the step S510.

According to one or more embodiments, the electronic apparatus 100 may obtain the first sensing data by sensing a work space corresponding to defined work information in the space around the electronic apparatus 100.

According to one or more embodiments, the electronic apparatus 100 may obtain the first sensing data by sensing a work space at a different height from the driving space through the first sensor for sensing the work space.

Then, the electronic apparatus 100 may identify whether a target object exists within the threshold distance in the step S520.

According to one or more embodiments, the electronic apparatus 100 may identify whether a defined target object exists within the threshold distance from the first target position included in the work information based on the first sensing data.

Here, as the threshold distance and the target object were explained in detail above, overlapping and/or redundant explanation(s) may be omitted.

Then, the electronic apparatus 100 may obtain the second target position in the step S530.

According to one or more embodiments, the electronic apparatus 100 may identify that the defined target object does not exist within the threshold distance. Here, the electronic apparatus 100 may identify that the target object does not exist within the threshold distance by using the map information of the work space.

The electronic apparatus 100 may obtain the second target position based on the second sensing data obtained by sensing the driving space. Here, the second target position may constitute a position within the threshold distance from the location of the target object. Here, the driving space may constitute a space different from the aforementioned work space.

The electronic apparatus 100 may detect a change in the environment of the work space based on the first sensing data as above, and generate a new location (or path) based on the second sensing data. A content of a detailed operation of the electronic apparatus 100 in this regard will be described in detail in the following parts.

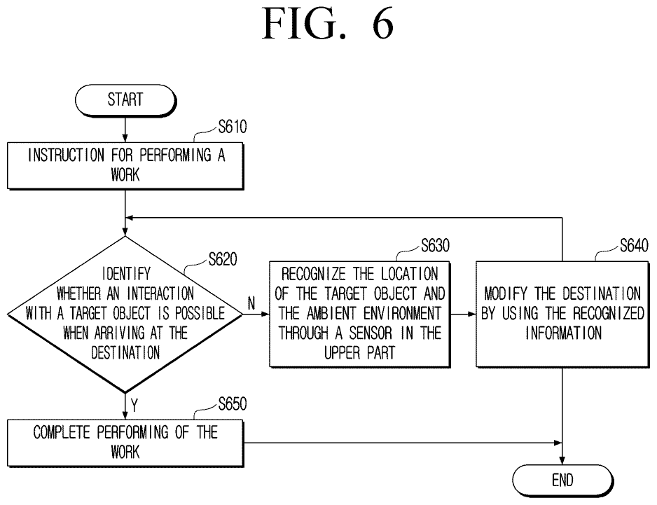

FIG. 6 is a flow chart for illustrating an operation of modifying a destination according to one or more embodiments of the disclosure.

According to FIG. 6, the electronic apparatus 100 may receive an instruction for performing a work in the step S610. Here, receiving an instruction for performing a work may mean receiving work information. For example, the electronic apparatus 100 may receive work information from an external device (e.g., an IoT server, etc.).

However, the disclosure is not limited thereto, and the electronic apparatus 100 may generate specific work information by itself. For example, the electronic apparatus 100 may generate work information by using map information obtained by sensing the surroundings of the electronic apparatus 100.

The electronic apparatus 100 may identify whether an interaction with a target object is possible after arriving at the destination in the step S620. Here, the target object may constitute a subject for the electronic apparatus 100 to perform a work. In the disclosure, a target object may also be referred to as a target, an object, etc.

Here, the interaction may mean an interaction between the electronic apparatus 100 and the target object. For example, the interaction may mean that the electronic apparatus 100 performs a specific work for the target object.

If it is identified that it is possible to perform a work at the destination where the electronic apparatus 100 arrived, the electronic apparatus 100 may perform the work and complete the work in the step S650.

In contrast, if it is identified that it would be impossible to perform a work at the destination where the electronic apparatus 100 arrived, the electronic apparatus 100 may recognize the location and the ambient environment of the target object through a sensor in the upper part in the step S630.

In other words, here, the sensor in the upper part may mean a sensor located in the upper part from among the lower part and the upper part of the electronic apparatus 100. Each of the upper part and the lower part may also be referred to as an upper part and a lower part.

The sensor in the upper part may mean the aforementioned first sensor. In this case, the electronic apparatus 100 may recognize the location and the ambient environment of the target object located in the work space through the sensor in the upper part.

The electronic apparatus 100 may recognize the location and the ambient environment of the target object by sensing the work space through the sensor in the upper part (and the sensor in the lower part).

The electronic apparatus 100 may modify the destination by using the recognized information in the step S640. For example, the electronic apparatus 100 may modify the destination by using information on the recognized location and ambient environment of the target object in the step S640. Here, the modified destination may constitute the second target position.

Hereinafter, an operation of the electronic apparatus 100 of recognizing the environment around the destination through an upper map obtained by using the sensor in the upper part will be described in detail.

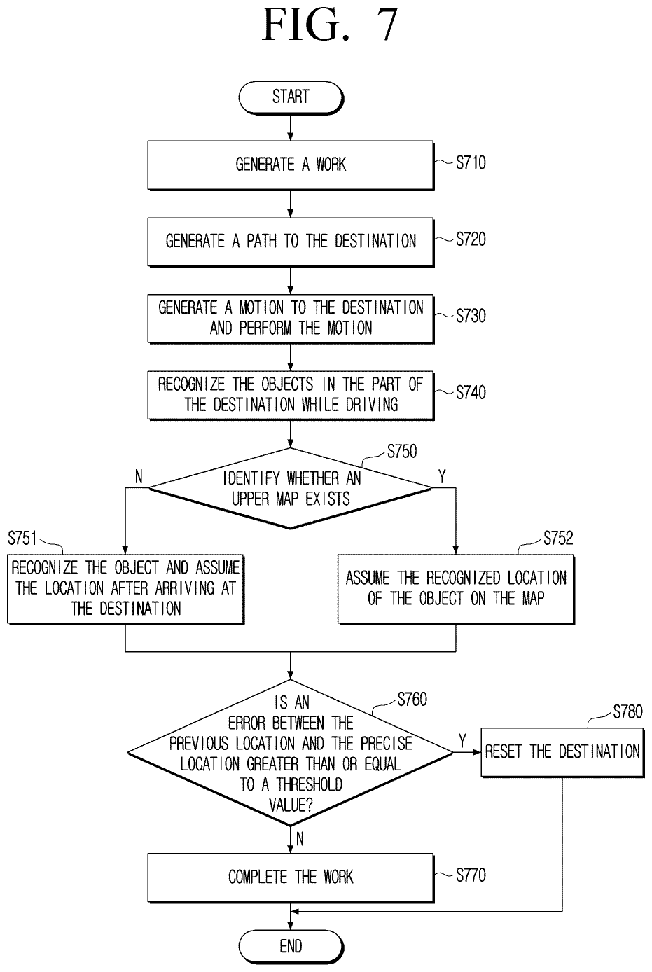

FIG. 7 is a flow chart for illustrating an operation based on an upper map according to one or more embodiments of the disclosure.

According to FIG. 7, the electronic apparatus 100 may generate a work in the step S710. The electronic apparatus 100 may generate a work based on the received work information. Here, as the received work information was explained in FIG. 6, overlapping and/or redundant explanation(s) may be omitted.

Then, the electronic apparatus 100 may generate a path to the destination in the step S720. For example, the electronic apparatus 100 may generate a path from information included in the work information. Here, the information included in the work information may include information on the location of the target object. However, the disclosure is not limited thereto.

Then, the electronic apparatus 100 may generate a motion to the destination, and perform an operation according to the generated motion and path in the step S730. Here, the motion may mean a posture of the electronic apparatus 100 for moving along the path.

Here, the information on the motion may constitute the information included in the work information. However, the disclosure is not limited thereto, and the electronic apparatus 100 may generate a motion by using the previously obtained map information. For example, the map information may constitute map information regarding the driving space.

The electronic apparatus 100 may determine whether an upper map exists in the step S750, and in the event an upper map does not exist, the electronic apparatus 100 may recognize the object after arriving at the destination and assume the location in the step S751. Here, the upper map may mean map information for the work space. Also, in the disclosure, the upper map may also be referred to as a map in the upper part.

Specifically, the upper map may constitute a map that the electronic apparatus 100 generated based on the previously obtained sensing data.

Also, the upper map may constitute a map that the electronic apparatus 100 received from an external device (e.g., an Internet-of-Things (IoT) server, etc.). For example, the map provided by the external device may constitute a map generated by a device that can communicate with the external device (e.g., an IoT device, etc.). Here, the device that can communicate with the external device may generate a map of the ambient space by sensing the ambient space.

In case an upper map is not stored in the electronic apparatus 100, the electronic apparatus 100 may arrive at the destination, and identify whether an object exists and its location. Here, whether an object exists may mean whether an object exists within a threshold distance from the point where the electronic apparatus 100 arrived (e.g., the first target position).

In contrast, if it is determined that an upper map exists in the electronic apparatus 100, the electronic apparatus 100 may assume the location wherein the object is recognized on the map in the step S752. For example, the electronic apparatus 100 may obtain location information of the object on the map. Specifically, the electronic apparatus 100 may assume the actual location of the object from the location of the object recognized on the map.

In other words, in the event an upper map is stored, the electronic apparatus 100 may identify that an object does not exist at the previous destination while moving to the previous destination (the destination according to the generated work). Accordingly, the electronic apparatus 100 may modify the destination according to the location wherein the object is recognized on the map without arriving at the destination.

The electronic apparatus 100 may identify whether an error between the previous location and the precise location is greater than or equal to a threshold value. Here, the precise location may mean the location of the object assumed by the electronic apparatus 100.

Here, the error may mean a difference between the location of the object assumed by the electronic apparatus 100 and the previous location. Also, here, the threshold value may mean a reference value set for determining whether a difference exceeded an acceptable range.

For example, the threshold value may be set according to a motion range of the robot arm provided on the electronic apparatus 100. In other words, even if an error exists, in the event the electronic apparatus 100 can perform a work in the previous location, the error may be smaller than the threshold value.

In case the error is smaller than the threshold value, the electronic apparatus 100 may perform the work in the previous location and complete the work in the step S770. In contrast, in the event the error is greater than or equal to the threshold value, the electronic apparatus 100 may reset the destination in the step S780.

A detailed content for an operation of the electronic apparatus 100 of resetting a destination and moving to a new destination will be described in the following parts.

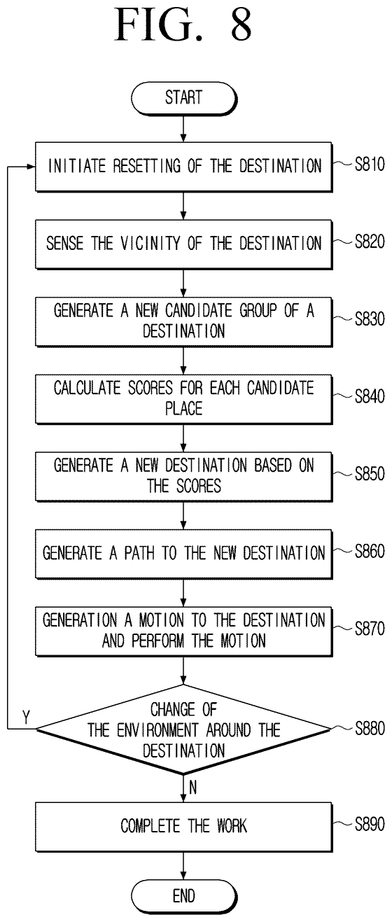

FIG. 8 is a flow chart for illustrating in detail an operation of modifying a destination according to one or more embodiments of the disclosure.

According to FIG. 8, the electronic apparatus 100 may initiate resetting of the destination in the step S810. Then, the electronic apparatus 100 may sense the surroundings of the object in the step S820.

For example, the electronic apparatus 100 may sense the surroundings of the object located in the work space. Here, the electronic apparatus 100 may sense the surroundings of the object by using the aforementioned upper (upper part) sensor. The electronic apparatus 100 may identify an object (e.g., a work interfering object) existing in the surroundings of the object based on the sensing data obtained by sensing the surroundings of the object.

Then, the electronic apparatus 100 may generate a new candidate group of a destination in the step S830. Here, the new candidate group of a destination may include a plurality of candidate places that the electronic apparatus 100 can select as a new destination. Here, the plurality of candidate places may constitute points located within a threshold distance from the location of the object.

Here, the locations of each of the plurality of candidate places may constitute the aforementioned candidate positions. Here, as the candidate positions were explained in detail above, overlapping and/or redundant explanation(s) may be omitted.

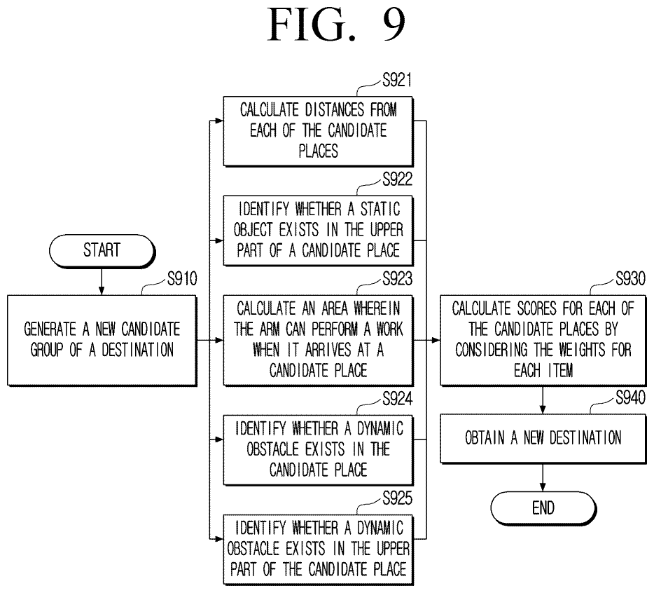

Then, the electronic apparatus 100 may calculate scores for each of the plurality of candidate places in the step S840. Then, the electronic apparatus 100 may generate a new destination based on the scores. Operations in this regard will be explained in detail through FIG. 9.

FIG. 9 is a flow chart for illustrating an operation of obtaining a new destination according to a score according to one or more embodiments of the disclosure.

According to FIG. 9, the electronic apparatus 100 may generate a new candidate group of a destination in the step S910, and then calculate scores for each of the candidate places.

Specifically, the electronic apparatus 100 may calculate distances from each of the candidate places in the step S921. For example, the electronic apparatus 100 may calculate distances from each of the candidate places by recognizing the current location and the ambient environment based on the sensing data (e.g., the second sensing data).

Here, the electronic apparatus 100 may recognize the current location of the electronic apparatus 100 through simultaneous localization and mapping (SLAM). Here, SLAM may mean an algorithm of assuming the location of itself (localization) by using sensing data, and generating and updating map information of the ambient environment in real time.

The electronic apparatus 100 may calculate the distances between the coordinates of each of the candidate places and the current location. Here, the coordinates of each of the candidate places may mean the location information on the map indicating the destination of the electronic apparatus 100.

Meanwhile, the electronic apparatus 100 may identify whether a static object exists in the upper part of each candidate place in the step S922.

Here, the upper part of a candidate place may mean an area in a work space located in the vicinity of each candidate place. Here, the vicinity may mean an area within the aforementioned threshold distance from a candidate place.

Here, a static obstacle may mean an obstacle recognized through the previous map information. In other words, a static obstacle may constitute an obstacle that exists in a fixed location in a work space.

For example, a static obstacle may constitute an object that is always fixed in the same location such as a shelf, a wall, a column, etc. existing in a work space. However, the disclosure is not limited thereto, and a static obstacle may constitute an object that is recognized from both of the previous map information and new map information, even if it is an object that can be moved by the user.

Meanwhile, the electronic apparatus 100 may calculate an area wherein the robot arm can perform a work when it arrives at a candidate place in the step S923. Here, the area wherein a work can be performed may mean the aforementioned motion range of the robot arm. Here, the motion range may be determined by the maximum distance wherein the robot arm can perform a work and an area occupied by an ambient obstacle, etc.

Meanwhile, the electronic apparatus 100 may identify whether a dynamic obstacle exists in the candidate place in the step S924.

Here, a dynamic obstacle may mean a movable obstacle that was not recognized from the previous map information, but was newly recognized through new sensing data. In other words, a dynamic obstacle may mean an obstacle that was recognized through newly generated map information. Here, the map information may mean map information of the driving space.

For example, a dynamic obstacle may constitute a person or a robot that is moving, or an object that was unexpectedly placed in the driving space.

Meanwhile, the electronic apparatus 100 may identify whether a dynamic obstacle exists in the upper part of the candidate place in the step S925. Here, the upper part of the candidate place may mean a work space located within a threshold distance from the candidate place.

Here, a dynamic obstacle may mean a movable obstacle that was not recognized from the previous map information, but was newly recognized through new sensing data. In other words, a dynamic obstacle may mean an obstacle that was recognized through newly generated map information.

For example, a dynamic obstacle may constitute a robot that appeared in the work space or an object that was unexpectedly placed.

The electronic apparatus 100 may calculate scores for each of the candidate places by using the information obtained through the aforementioned process (the information on the dynamic/static obstacles, the distance, the motion range of the arm, etc.).

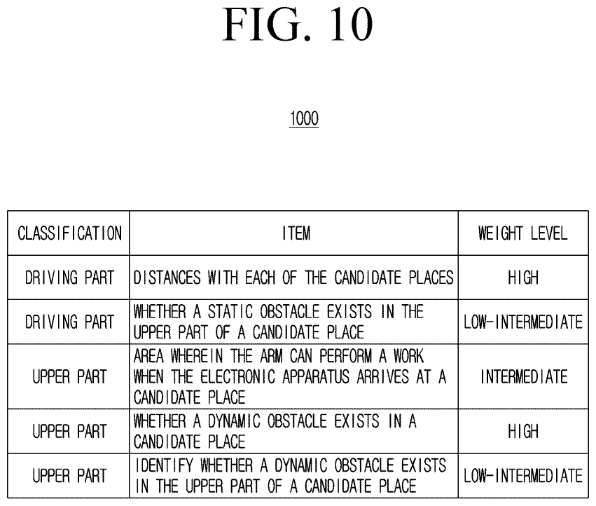

The electronic apparatus 100 may calculate scores for each of the candidate places by considering the weights for each item in the step S930. Here, the weights for each item may constitute weights set for each of the plurality of types described above. In the disclosure, the items may also be referred to as types. Explanation in this regard will be described in detail in FIG. 10.

FIG. 10 is a diagram for illustrating weights according to one or more embodiments of the disclosure.

According to FIG. 10, a table 1000 indicating items and weight levels for each classification is illustrated.

Here, the classifications may mean classifications according to locations of sensors in the event the electronic apparatus 100 includes a plurality of sensors.

Here, the plurality of sensors may constitute the aforementioned first sensor and second sensor. For example, the first sensor may be a sensor arranged at the height of the driving part, and the second sensor may mean a sensor arranged in the upper part. Also, here, a sensor may mean the robot arm.

However, the disclosure is not limited thereto, and even in the event the electronic apparatus 100 includes a single sensor, or in the event the location (e.g., the height) of the sensor can be changed through a separate driving device, the classifications may mean classifications according to locations wherein the single sensor senses the surroundings.

The plurality of items included in the table 1000 may be classified into one of the driving part or the upper part. In other words, the plurality of items may mean information regarding an environment related to one of the driving part or the upper part.

For example, the electronic apparatus 100 may identify the distances with each of the candidate places and whether a static obstacle exists in the upper part of a candidate place through the sensor in the driving part.

Then, the electronic apparatus 100 may identify an area wherein the arm can perform a work when the electronic apparatus 100 arrives at a candidate place, whether a dynamic obstacle exists in the candidate place, whether a dynamic obstacle exists in the upper part of the candidate place, and whether a static obstacle exists in the upper part of the candidate place through the upper sensor.

Meanwhile, the weight levels may be set for each item. Here, the weight levels may mean levels classified into several levels according to the relative importance of each item. Also, here, the importance may indicate the degree to which the information of each type exerts influence when an optimal candidate position is selected.

As described above, the importance of each item may be set through weights (real number values), but it may also be set as levels as above.

For example, the distances with each of the candidate places may be set as a top level, whether a static obstacle exists in the upper part of a candidate place may be set as a low-intermediate level, whether the arm can perform a work when the electronic apparatus 100 arrives at a candidate place may be set as an intermediate level, whether a dynamic obstacle exists in a candidate place may be set as a high level, and whether a dynamic obstacle exists in the upper part of a candidate place may be set as a low-intermediate level.

However, this is merely an example, and the number of the items, the contents of each item, and the weight levels for each item may be set in various ways according to the user setting as well as other factors. For example, in the event the electronic apparatus 100 includes a robot arm, if the robot arm causes power consumption relatively higher than the other components, ‘an area wherein the arm can perform a work when the electronic apparatus 100 arrives at a candidate place’ may be set as ‘high.’

As described above, the electronic apparatus 100 may obtain information for each item for each candidate place by sensing the driving space and the work space. Here, the information on each item may constitute the aforementioned destination characteristic information. Then, the electronic apparatus 100 may calculate the scores for each candidate place by using the set weight levels (or weights).

Here, the electronic apparatus 100 may digitize items related to whether an obstacle exists as 0 (an obstacle exists) or 1 (an obstacle does not exist). However, the disclosure is not limited thereto. Meanwhile, in the event weight levels instead of weights (real number values) were set, the electronic apparatus 100 may digitize the weight levels into weights according to the levels. In this case, the electronic apparatus 100 may digitize higher weight levels into higher weights.

The electronic apparatus 100 may calculate a weighted sum for each of the plurality of candidate places based on the digitized values and the weights from the information on each item. Here, a weighted sum for each of the plurality of candidate places may constitute a score of each of the plurality of candidate places.

Here, the score may mean a reference value for evaluating the priority or adequacy of a candidate place in the candidate group of a destination. Here, the adequacy may mean the degree of being adequate for the final destination. Also, here, the final destination may mean the second target position.

Returning to FIG. 9, the electronic apparatus 100 may obtain a new destination in the step S940. Specifically, the electronic apparatus 100 may obtain a new destination based on the scores for each of the plurality of candidate places. For example, the electronic apparatus 100 may obtain a candidate place corresponding to the biggest score among the plurality of scores as the final destination. However, the disclosure is not limited thereto.

Returning to FIG. 8, the electronic apparatus 100 may generate a path to a new destination in the step S860. The electronic apparatus 100 may generate a path based on sensing data obtained by sensing the driving space. In other words, the electronic apparatus 100 may generate a path that can avoid obstacles (e.g., driving obstacle objects) that appeared on the map information by using the map information of the driving space.

Then, the electronic apparatus 100 may generate a motion to the destination, and perform the generated motion and an operation according to the path in the step S870. Here, as explanation regarding the motion and the path was already described, overlapping and/or redundant explanation(s) may be omitted.

Then, the electronic apparatus 100 may move along the generated path, and identify whether a change of the environment around the destination exists in the step S880. Here, the destination may constitute a newly generated destination.

Specifically, the electronic apparatus 100 may generate new map information by using the newly obtained sensing data while moving along the generated path. Here, the map information may constitute the map information of the driving space or the map information of the work space, etc.

Here, a change of the environment may mean a change that can modify the destination. For example, the feature that a change of the environment exists may mean that a new object (a new obstacle object) appears around a new destination, or an object moves to another location, etc.

If it is identified that a change of the environment around the destination exists, the electronic apparatus 100 may re-initiate resetting of the destination in the step S810. Afterwards, the electronic apparatus 100 may perform the aforementioned processes (a process of sensing the vicinity of the destination, a process of generating one of the plurality of candidate places as a new destination, etc.).

In contrast, if it is identified that a change of the environment around the destination did not occur, the electronic apparatus 100 may perform a work, and complete the work in the step S890. For example, if it is identified that a change of the environment around the destination does not exist until the electronic apparatus 100 arrives at the destination, and the previous environment is maintained, the electronic apparatus 100 may perform the planned work after arriving at the destination.

As described above, the electronic apparatus 100 can continuously detect a change of the ambient environment while moving to the previous destination for performing a work. In particular, the electronic apparatus 100 can recognize not only a space for a work, but also a space for driving through a plurality of sensors, and can thereby cope with a change of the environment that occurs on a planned path as well as the vicinity of the destination.

Through this, the electronic apparatus 100 can not only complete a work more swiftly by replanning a destination and a path (and a motion) continuously, but also reduce the entire power consumption.

Meanwhile, in FIGS. 5 to 9, orders were mapped to all steps for the convenience of explanation, but it is readily apparent that the orders of steps that are not related to orders or that can be performed in parallel, etc. are not necessarily limited to the orders.

Meanwhile, methods according to at least some of the aforementioned various embodiments of the disclosure may be implemented in forms of applications that may be installed on conventional electronic apparatuses.

Also, the methods according to at least some of the aforementioned various embodiments of the disclosure may be implemented with software upgrade, or hardware upgrade of conventional electronic apparatuses.

In addition, the methods according to at least some of the aforementioned various embodiments of the disclosure may also be performed through an embedded server provided on an electronic apparatus, or an external server of at least one of electronic apparatuses.

Meanwhile, according to one or more embodiments of the disclosure, the aforementioned various embodiments may be implemented as software including instructions stored in machine-readable storage media, which can be read by machines (e.g., computers). The machines refer to apparatuses that call instructions stored in a storage medium, and can operate according to the called instructions, and the apparatuses may include the electronic apparatus according to the embodiments disclosed herein (e.g., the electronic apparatus 100). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘a non-transitory storage medium’ only means that the storage medium is a tangible device, and does not include signals (e.g., electromagnetic waves), and the term does not distinguish a case wherein data is stored semi-permanently in a storage medium and a case wherein data is stored temporarily. For example, ‘a non-transitory storage medium’ may include a buffer wherein data is temporarily stored.

Also, according to one or more embodiments, the methods according to the various embodiments disclosed herein may be provided while being included in a computer program product. A computer program product refers to a product, and it can be traded between a seller and a buyer. A computer program product can be distributed in the form of a storage medium that is readable by machines (e.g., compact disc read only memory (CD-ROM)), or distributed on-line (e.g., download or upload) through an application store (e.g., Play Store™), or directly between two user devices (e.g., smartphones). In the case of on-line distribution, at least a portion of a computer program product (e.g., a downloadable app) may be stored in a storage medium readable by machines such as the server of the manufacturer, the server of the application store, and the memory of the relay server at least temporarily, or may be generated temporarily.

In addition, the various embodiments of the disclosure may be implemented as software including instructions stored in machine-readable storage media, which can be read by machines (e.g., computers). The machines refer to apparatuses that call instructions stored in a storage medium, and can operate according to the called instructions, and the apparatuses may include the electronic apparatus according to the embodiments disclosed herein (e.g., the electronic apparatus 100).

In the event an instruction is executed by a processor, the processor may perform a function corresponding to the instruction by itself, or by using other components under its control. An instruction may include a code that is generated or executed by a compiler or an interpreter.

Also, while preferred embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic apparatus comprising:
memory storing instructions;
at least one sensor for sensing a space around the electronic apparatus; and
at least one processor including processing circuitry,
wherein the instructions, when executed by the at least one processor individually or collectively, cause the electronic apparatus to:
obtain first sensing data by sensing a work space through the at least one sensor, the work space corresponding to defined work information in the space, and
based on identifying, on basis of the first sensing data, that a defined target object is not within a threshold distance from a first target position included in the defined work information, obtain a second target position within the threshold distance from a location of the defined target object on basis of second sensing data obtained by sensing a driving space different from the work space.

2. The electronic apparatus of claim 1, wherein the at least one sensor comprises:
a first sensor configured to sense the work space; and
a second sensor at a different height from the first sensor,
wherein the instructions, when executed by the at least one processor individually or collectively, further cause the electronic apparatus to:
sense, through the first sensor, the work space at a different height from the driving space, and
obtain, through the second sensor, the second target position based on the second sensing data obtained by sensing the driving space.

3. The electronic apparatus of claim 1, further comprising:
a mobile device configured to move the electronic apparatus,
wherein the instructions, when executed by the at least one processor individually or collectively, further cause the electronic apparatus to:
control the mobile device to move to the first target position, and
sense the work space through the at least one sensor while moving.

4. The electronic apparatus of claim 3,
wherein the instructions, when executed by the at least one processor individually or collectively, further cause the electronic apparatus to:
obtain the first target position based on previous sensing data obtained through the at least one sensor and the defined work information, and
based on identifying that the defined target object is not within a threshold distance from the first target position on the basis of first sensing data different from the previous sensing data while moving to the first target position, obtain the second target position.

5. The electronic apparatus of claim 1,
wherein the instructions, when executed by the at least one processor individually or collectively, further cause the electronic apparatus to:
based on at least one of the first sensing data or the second sensing data, identify at least one obstacle object in a target area within the threshold distance from the location of the defined target object,
identify a remaining area of the target area excluding an area occupied by the identified at least one obstacle object in the target area, and
obtain the second target position included in the remaining area.

6. The electronic apparatus of claim 5,
wherein the instructions, when executed by the at least one processor individually or collectively, further cause the electronic apparatus to:
identify at least one driving obstacle object located in the driving space on the basis of the second sensing data, and
identify a remaining area of the driving space excluding an area occupied by the identified at least one driving obstacle object in the driving space.

7. The electronic apparatus of claim 6,
wherein the instructions, when executed by the at least one processor individually or collectively, further cause the electronic apparatus to:
obtain a plurality of candidate positions in the remaining area,
obtain a plurality of scores based on destination characteristic information obtained from at least one of the first sensing data or the second sensing data, and
obtain the second target position among the plurality of candidate positions included in the remaining area of the target area based on the plurality of scores.

8. The electronic apparatus of claim 7,
wherein the instructions, when executed by the at least one processor individually or collectively, further cause the electronic apparatus to:
obtain the destination characteristic information including information organized according to a plurality of types for each of the plurality of candidate positions from at least one of the first sensing data or the second sensing data, and
obtain scores for each of the candidate positions based on a plurality of weights set for each of the plurality of types.

9. The electronic apparatus of claim 1,
wherein the instructions, when executed by the at least one processor individually or collectively, further cause the electronic apparatus to:
obtain path information wherein the obtained second target position is a destination based on the second sensing data, and
update the defined work information based on the obtained path information and the second target position.

10. The electronic apparatus of claim 9,
wherein the instructions, when executed by the at least one processor individually or collectively, further cause the electronic apparatus to:
obtain motion information based on at least one driving obstacle identified from the second sensing data, and
obtain the path information including the obtained motion information.

11. A control method of an electronic apparatus, the method comprising:
obtaining first sensing data by sensing a work space corresponding to defined work information in a space around the electronic apparatus;
identifying whether a defined target object is within a threshold distance from a first target position included in the defined work information on basis of the first sensing data; and
based on identifying that the defined target object is not within the threshold distance, obtaining a second target position within the threshold distance from the location of the defined target object on basis of second sensing data obtained by sensing a driving space different from the work space.

12. The control method of claim 11, wherein the obtaining the first sensing data comprises:
obtaining the first sensing data by sensing, through a first sensor, the work space at a different height from the driving space, and
the obtaining the second target position comprises:
obtaining the second target position based on the second sensing data, the second sensing data obtained by sensing the work space through a second sensor at a different height from the first sensor.

13. The control method of claim 11, further comprising:
controlling the electronic apparatus to move the electronic apparatus to the first target position,
wherein the obtaining the second target position further comprises:
obtaining the second target position based on the second sensing data, the second sensing data obtained by sensing the work space while moving.

14. The control method of claim 13, further comprising:
obtaining the first target position based on previous sensing data and the defined work information,
wherein the identifying whether the defined target object is within the threshold distance further comprises:
identifying whether the defined target object is within a threshold distance from the first target position on the basis of first sensing data different from the previous sensing data while moving to the first target position.

15. A non-transitory computer-readable recording medium storing computer instructions which, when executed by a processor of an electronic apparatus, cause the electronic apparatus to perform operations,
wherein the operations comprise:
obtaining first sensing data by sensing a work space corresponding to defined work information in a space around the electronic apparatus;
identifying whether a defined target object is within a threshold distance from a first target position in the defined work information on the basis of the first sensing data; and
based on identifying that the defined target object is not within the threshold distance, obtaining a second target position within the threshold distance from a location of the defined target object on the basis of second sensing data obtained by sensing a driving space different from the work space.
